(19) United States
(12) Patent Application Publication
(10) Pub. No.: US 2021/0029437 A1
(43) Pub. Date: Jan. 28, 2021

(54) STRUCTURE OF EARPLUG

(71) Applicant: TOONG IN ELECTRONIC CORP., NEW TAIPEI CITY (TW)

(72) Inventor: TENG-SONG TSENG, NEW TAIPEI CITY (TW)

(21) Appl. No.: 16/672,788

(22) Filed: Nov. 4, 2019

(30) Foreign Application Priority Data
Jul. 23, 2019 (TW) 108125936

(51) Int. Cl. H04R 1/10

(52) U.S. Cl. CPC H04R 1/1016; H04R 1/1058

(57) ABSTRACT

The present application is a structure of an earplug, which is arranged on an earphone. The structure of said earplug includes a casing and a shaft portion, the casing includes a first opening and a second opening. The earplug further including at least one through hole, the perforation communicating with the first opening. While using the earphone of the present application, the ear is kept in ventilative by at least one through hole

### FIELD OF THE INVENTION

The present invention relates generally to a structure of earplug, and particularly to a structure of in-ear earplug.

### BACKGROUND OF THE INVENTION

Earphones, also known as headphones or headsets, are a pair of converting units. They receive the electric signals transmitted by media players or receivers and convert the signals to audible sound waves by using the speakers close to the ears. In general, earphones can be separated from media players and they can be connected through a jack. The advantage of the device is individual music listening without interfering others. In addition, it can also isolate the environmental sound, which is helpful for users in noisy environments, such as recording studios, DJ, travel, and sports.

Earphones are first designed for telephones and radios. Following the prevalence of portable electronic devices and people's behavioral changes in audio and video entertainments, earphones are now mostly applied to mobile phone, walkmans, radios, portable video games, and digital music players. In addition, they are also adopted in computers and Hi-Fi systems.

According to the sound driving methods using transducers (transduction principle), earphones include dynamic coil, electrostatic, piezoelectric, dynamic iron, pneumatic, and electromagnetic types. According to the forms of interface, earphones include open, semi-open, and closed (airtight) types. According to the wearing methods, earphones can be categorized into circumaural, supra-aural, earbuds, in-ear, ear-hook, and around-ear types.

Nonetheless, among the various earphone types, except for the circumaural, supra-aural, ear-hook types, which allow hearing of environmental sound while wearing, it is difficult for the rest types, such as the around-ear or in-ear type, to do so owing to the usage of earplugs. Consequently, while riding a motorcycle or a bicycle wearing in-ear or around-ear earphones according to the prior art, due to the airtight condition, the user cannot hear the environmental sound.

In addition, modern people usually exercise accompanying the beats of music. Thereby, sports type earphones are adopted. In exercises, the in-ear (generally Bluetooth) or around-ear earphones are usually used. For these two types of earphones, earplugs are required. By means of earplugs, people can listen to the music quietly while doing exercises, allowing body rhythms coherent to the music. So, due to the sweat in exercises, there will be moisture inside the ears, and leading discomfort feelings generated inside the ears.

The materials of the earplugs used in commercial earphones include silica gel, form rubber, in-ear air gel, or shape-memory polyurethane. The silica gel is the most common material for the earplugs of earphones. Thanks to its softness, ears contacting the material won't be uncomfortable. Besides, the material is durable. Silica gel is appropriate for various types of music. The performance for low-pitched sound is particularly vivid and strong, making it very suitable for rock and roll with heavy beats. On the other hand, foam rubber (polyether polyurethane) is the so-called memory foam. It is 30 times softer than normal silica gel earplugs. Since it is ventilative and elastic, it can be adapted to various shapes of human ears and enabling comfortable wearing experience. Even for long-term wearing, people won't feel sore at ears, making the material extremely suitable for the music types with long playing time such as classic music. Moreover, the in-ear air gel is also highly adaptive and airtight. Although it feels sticky when wearing, the material has exceptional property in sound isolation, making it appropriate for usage in public transit vehicles such as trains, automobiles, and airplanes for various music types including pop or jazz. Besides, the shape-memory polyurethane owns the properties of high vibration absorption and slow rebound. It also performs excellently in noise reduction, making it highly recommended in outdoor usage.

All types of earplugs emphasize in isolation of environmental sound, noise reduction, or airtightness in earphone applications, which, unfortunately, make them inappropriate for riding motorcycles or bicycles or exercises. Excessive airtight property and isolation of environmental sound induce safety concerns. Thereby, how to ensure riding safety when a user listens to the music by earphones has become an urgent challenge.

Accordingly, the present invention provides a structure of earplug, which is applied to earphones. While wearing the earphones including the structure of earplug according to the present invention, the structure balances the pressure inside and outside ears without isolating the environmental sound. Thereby, the external sound can be heard and thus ensuring the safety in exercises or riding.

### SUMMARY

An objective of the present invention is to provide a structure of earplug. While wearing earphones, by means of the structure of earplug according to the present invention, the environmental sound can be heard, as well as balancing the pressure inside and outside the ears.

To achieve the above objective, the present invention provides a structure of earplug, which is disposed at a sound outlet of an earphone, and comprises a casing and a shaft portion. The casing includes a first opening and a second opening. The first opening is disposed on one side of the casing; the second opening is disposed on the other side of the casing. Furthermore, the casing includes at least one through hole. In addition, the shaft portion is disposed inside the casing and includes a perforation. One side of the perforation communicates with the first opening.

According to an embodiment of the present invention, the sound outlet of the earphone includes a first flange surrounding one side of the sound outlet. The shaft portion slips over the first flange.

According to an embodiment of the present invention, the shaft portion further includes a crenelated part. The crenelated part includes a plurality of second flanges. One of the plurality of second flanges secures the first flange.

According to an embodiment of the present invention, the first flange includes a first inclined plane; the plurality of second flanges include a second inclined plane, respectively. The first slop is against the second inclined plane.

According to an embodiment of the present invention, the casing further includes a flat part and a curved part. The at least one through hole is disposed at the curved part.

According to an embodiment of the present invention, the structure of earplug is manufactured by silica gel or rubber.

According to an embodiment of the present invention, the hardness coefficient of the structure of earplug is between 40 and 60.

According to an embodiment of the present invention, the structure of earplug is used in in-ear earphones or around-ear earphones.

### BRIEF DESCRIPTION OF THE DRAWINGS

FIG. 1 shows a schematic diagram of disassembly according to an embodiment of the present invention;

FIG. 2 shows a structure diagram of the earplug according to an embodiment of the present invention;

FIG. 3A shows a schematic diagram of the usage status according to an embodiment of the present invention;

FIG. 3B shows an enlarged view of the usage status according to an embodiment of the present invention; and

FIG. 4 shows a structural schematic diagram of the crenelated part according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The earplugs used in-ear-headphones (Bluetooth or general wired in-ear headphones) or ear-hook headphones have only the functions of airtightness and noise isolation. They do not allow hearing of environmental sound nor excellent ventilation. Thereby, after each application, there is some minor moisture inside ears. They also disallow user's hearing of environmental sound, leading to safety concerns.

The present invention improves the earplugs according to the prior art and balances the pressure inside and outside ears. In addition, the environmental sound is not blocked. By hearing the environmental sound while wearing, the safety in exercises or riding can be ensured.

In the following, the detailed description of the present invention is provided as follows along with embodiments and accompanying figures. The concepts of the present invention can be embodied by various forms. Those embodiments are not used to limit the scope and range of the present invention.

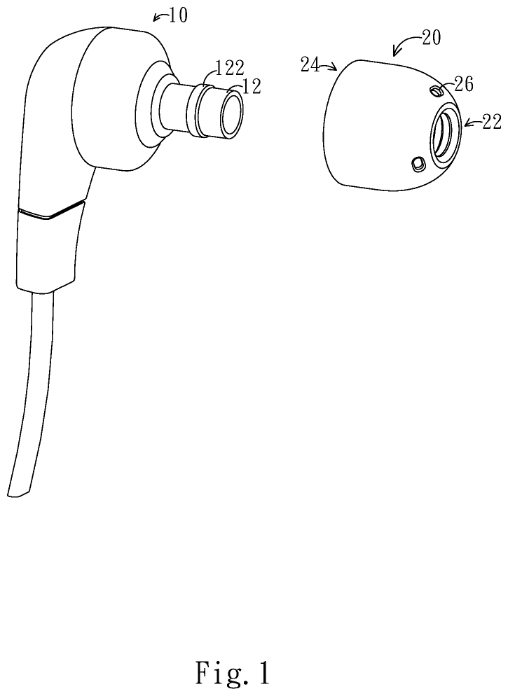

First, please refer to FIG. 1, which shows a schematic diagram of disassembly according to an embodiment of the present invention. As shown in the figure, an earplug 1 according to the present invention is fixed to an earphone 10. The structure of earplug 1 comprises a casing 20 and a shaft portion 30.

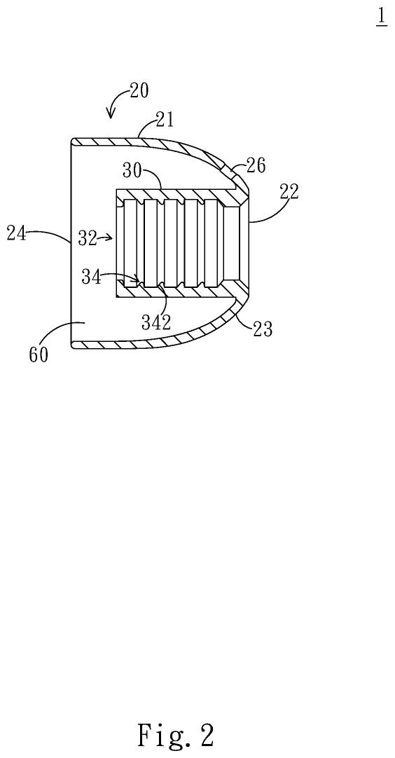

Next, please refer to FIG. 2, which shows a structure diagram of the earplug according to an embodiment of the present invention. As shown in the figure, the casing 20 includes a first opening 22 and a second opening 24. The first opening 22 is disposed on one side of the casing 20; the second opening 24 is disposed on the other side of the casing 20. The first opening 22 and the second opening 24 are disposed opposing to each other. Furthermore, the casing 20 includes at least one through hole 26. In addition, the shaft portion 30 is disposed inside the casing 20 and includes a perforation 32. One side of the perforation 32 communicates with the first opening 22 on the first opening 22. The casing 20 and the shaft portion 30 include an ambient space 60. The at least one through hole 26 communicates with the second opening 24 via the ambient space 60.

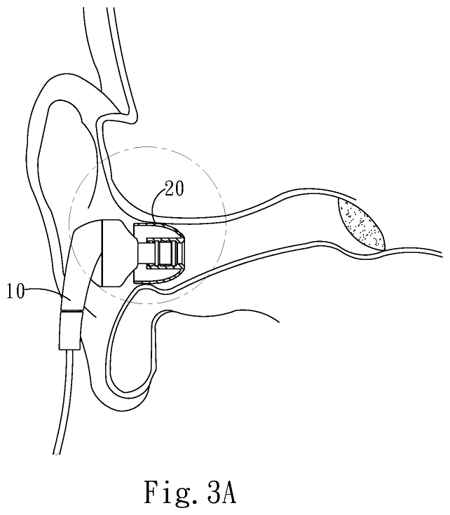

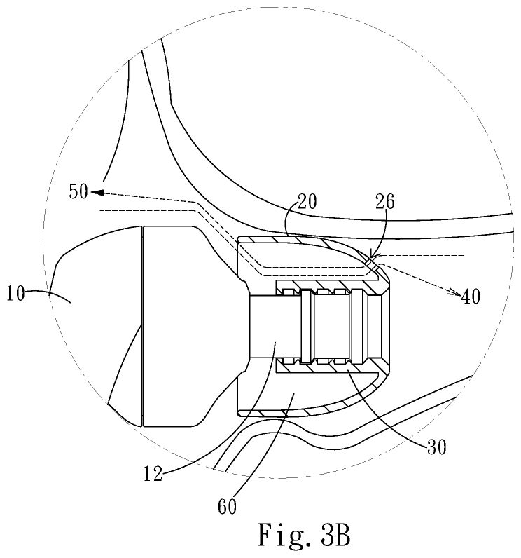

The earplug 1 is fixed behind a sound outlet 12 of the earphone 10 through the shaft portion 30. Please refer to FIG. 3A, which shows a schematic diagram of the usage status according to an embodiment of the present invention, and FIG. 3B, which shows an enlarged view of the usage status according to an embodiment of the present invention. As shown in the figures, the earplug 1 according to the present embodiment is disposed at the earphone 10 before attaching into a human ear for listening to music. By using the at least one through hole 26 in the earplug 1 of the earphone 10, when people wear the earphone 10, an environmental sound 40 can be heard, preventing the danger of not hearing the environmental sound 40 owing to the ears being plugged. Moreover, a moisture 50 generated inside the ears can be exhausted through the at least one through holes 26 while wearing the earphone 10.

The goal of the earphones 10 according to the prior art is to promise the user an individual and private environment for appreciating music. Thereby, the earplug 1 adopted on the earphone 10, in the perspectives of material selection or structure design, tends to have excellent airtightness. Unfortunately, this design is suitable for users in a static environment. If the user is moving, such as walking down the street, riding motorcycles or bicycles, or exercising, there will be safety concerns because the environmental sound 40 cannot be heard. In addition, since the main emphasis of the earphones 10 is excellent airtightness, the moisture 50 inside the ears wearing the earphones 10 cannot be exhausted.

Besides, the most adopted material for the earplugs 1 of the earphones 10 according to the prior art is rubber or silica gel. Rubber is a highly elastic and sticky material. Its elasticity is originated form the variation of coiled molecules. The interaction among rubber molecules will obstruct the motion of the molecular chains as well as exhibiting viscosity, making the stress and strain imbalanced. There is weaker secondary force in the structure of coiled long-chain rubber molecules and among them. Thereby, rubber materials exhibit unique sticky and elastic properties, and hence enabling it superior vibration absorption, sound isolation, and buffering properties. It is the very reason that makes the earplug 1 according to the present embodiment performs excellently in sound isolation.

Furthermore, the silica gel described above is also called silicone, organic silica gel, and polysiloxane resin. It is a thermoset resin using silicon and oxygen as the main structure. According to the form, it can be categorized into solid silica gel and liquid silica gel. According to the type, silica gel can be categorized into condensation type and addition type. Silica gel is high-temperature tolerant, weather tolerant, chemical resistive, waterproof, and sound isolative. In addition, it has superior softness. Organic silica gel has high tearing strength (up to 250 ppi) and tensile strength (up to 1500 ppi). It also own excellent elongation (up to 1250%) and flexibility, low compressive deformation, and a Shore A hardness range from 5 to 80. Softer silicon resin can maintain softness unlimitedly. The softest hardness can be provided in the form of reinforced gel.

Although the earplug 1 fixed to the earphone 10 according to the present embodiment also adopt silicon gel or rubber, the present invention is not limited to the materials. The earplug 1 comprises the at least one through hole 26, which improves the safety concern of inability of hearing the environmental sound 40 while wearing the earphone 10 according to the prior art. In addition, the at least one through hole 26 allows the moisture 50 inside the ear to be exhausted. Without the vapor adhered to the earplug 1, the possibility of staining the earplug 1 with dirty objects can be reduced.

Moreover, the casing 20 according to the present embodiment further includes a flat part 21 and a curved part 23. The at least one through hole 26 is disposed in the curved part 23. If the at least one through hole 26 is plural, the plurality of through holes 26 surround the curved part 23. Besides, some special shapes can be designed to the curved part 23 to make the earplug 1 more fashionable.

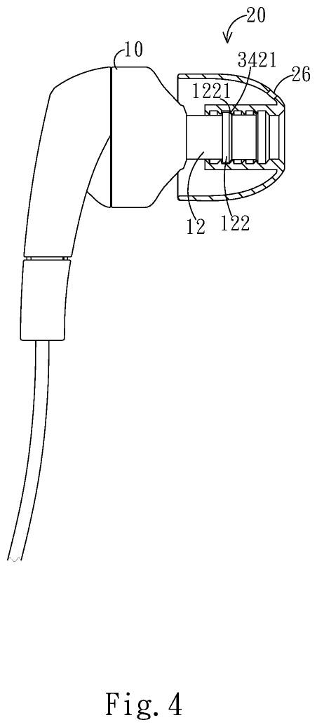

In addition, the shaft portion 30 according to the present embodiment further includes a crenelated part 34 on the inner side. The crenelated part 34 can slip over a first flange 122 on the sound outlet 12 of the earphone 10. Please refer to FIG. 2, which shows a structure diagram of the earplug according to an embodiment of the present invention, and to FIG. 4, which shows a structural schematic diagram of the crenelated part according to an embodiment of the present invention. As shown in the figures, the crenelated part 34 includes a plurality of second flanges 342. One of the plurality of second flanges 342 secures the first flange 122. The first flange 122 includes a first inclined plane 1221. The plurality of second flanges 342 include a second inclined plane 122, respectively. The first slop 1221 is against the second inclined plane 3421 for fixing the earplug 1 to the earphone 10. According to the location of the first flange 122, the first flange 122 can be secured to the corresponding second flange 342, so that the earplug 1 can adapt to various commercial in-ear earphones with different lengths of sound outlet 12.

The embodiments described above according to the method of the present invention is used to manufacture an earplug for earphones. Through holes are disposed in the earplug. By using the through holes, the pressure inside and outside an ear can be balanced and the environmental sound will not be blocked. Thereby, the external sound can be heard while wearing, ensuring the safety in exercises or riding.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A structure of earplug, disposed at a sound outlet of an earphone, comprising:
a casing, including a first opening and a second opening, said first opening disposed on one side of said casing, said second opening disposed on the other side of said casing, and said casing further including at least one through hole; and
a shaft portion, disposed inside said casing, including a perforation, and one side of said perforation communicating with said first opening;
where said casing and said shaft portion form a ambient space.

2. The structure of earplug of claim 1, wherein said sound outlet of said earphone includes a first flange surrounding one side of said sound outlet; and said shaft portion slips over said first flange.

3. The structure of earplug of claim 1, wherein said shaft portion further includes a crenelated part on the inner sider; said crenelated part includes a plurality of second flanges; and one of said plurality of second flanges secures a first flange.

4. The structure of earplug of claim 2, wherein said first flange includes a first inclined plane.

5. The structure of earplug of claim 3, wherein said first flange includes a first inclined plane, and said plurality of second flanges included a second inclined plane, said first inclined plane is against said second inclined plane.

6. The structure of earplug of claim 1, wherein said casing further includes a flat part and a curved part; and said at least one through hole is disposed in said curved part.

7. The structure of earplug of claim 1, wherein said structure of earplug is manufactured by silica gel or rubber.

8. The structure of earplug of claim 1, wherein the hardness coefficient of said structure of earplug is between 40 and 60.

9. The structure of earplug of claim 1, wherein said structure of earplug is applied to in-ear earphones or around-ear earphones.
